(19) United States
(12) Patent Application Publication
(10) Pub. No.: US 2006/0011359 A1
(43) Pub. Date: Jan. 19, 2006

(54) One point hitch

(76) Inventor: William Arthur Fowble III, Upperco, MD (US)

Correspondence Address: William A. Fowble, 17200 Falls Road, Upperco, MD, 21155, US

(21) Appl. No.: 10/890,638

(22) Filed: Jul. 14, 2004

(51) Int. Cl. B62C 7/00; B62C 11/00; A01B 59/00

(52) U.S. Cl. 172/677; 280/186

(57) ABSTRACT

This invention relates to an invention of a novel detachable garden type apparatus that allows varying types of farm, garden and similar type implements to be attached to, removed and exchanged from the One Point Hitch as desired that is towed behind a small farm or garden tractor or similar type of pulling device. This invention is operated by an electromechanical or hydraulic lifting and lowering mechanism supplied by others which can easily be raised and lowered by the tractor operator using a valve or electrical type switch. The novel apparatus of this invention has the capability to receive and utilize numerous optional attachments such as a tilling disk apparatus, drag chain attachment, scaring tooth, and useful framing other like devices. The apparatus of this invention works with a small farm or garden tractor unit equipped with a plate tow capability having only a small diameter hole in the tow plate or a trailer type ball hitch and does not require a three point hitch or other type of lift mechanism. The purpose of this invention is to allow the use of farm or garden type implements to be used without the need for a tractor mounted three point hitch or similar type of lifting apparatus.

### BACKGROUND OF THE INVENTION

1. Field of the Invention

No changes to patent # U.S. Pat. No. 6,286,608 B1

2. Description of the Prior Art

No changes to patent # U.S. Pat. No. 6,286,608 B1

### SUMMARY OF THE INVENTION

In accordance with this improvement to the original invention, a detachable One Point Hitch garden type mounting frame is towed behind a small farm or garden tractor unit which will allow the user to attach any device desired to be for multiple purposes. This apparatus includes a horizontal support frame affixed to two rotatable wheels and having two parallel support frame members hingedly attached to a transport device frame affixed to a garden tractor or similar pulling unit mounting tongue or plate type tow hitch. The desired device is attached to the mounting brackets at the rear of the apparatus and is raised and lowered using an electromechanical or hydraulic device as available on the open market. The lifting device is not a part of the improvements to the original patent no. U.S. Pat. No. 6,286,608 B1.

Although only a few exemplary embodiments of the present invention have been described in detail above, those skilled in the art will readily appreciate that many modifications and substitutions are possible in the exemplary embodiments without materially departing from the novel teachings and advantages of the invention.

### BRIEF DESCRIPTION OF DRAWINGS

Additional drawings

FIG. 9 is a right side view of the preferred embodiment of the detachable One Point Hitch of this invention showing the apparatus in the full depth position.

FIG. 10 is a right side view of the preferred embodiment of the detachable One Point Hitch in the transport position.

FIG. 11 is a rear view of the preferred embodiment of the detachable One Point Hitch in the full depth position.

FIG. 12 is a rear view of the preferred embodiment of the detachable One Point Hitch in the transport position.

### DETAILED DESCRIPTION

Referring to drawings numbers 9, 10, 11, and 12 for a better understanding of the improvements to patent no. U.S. Pat. No. 6,286,608 B1.

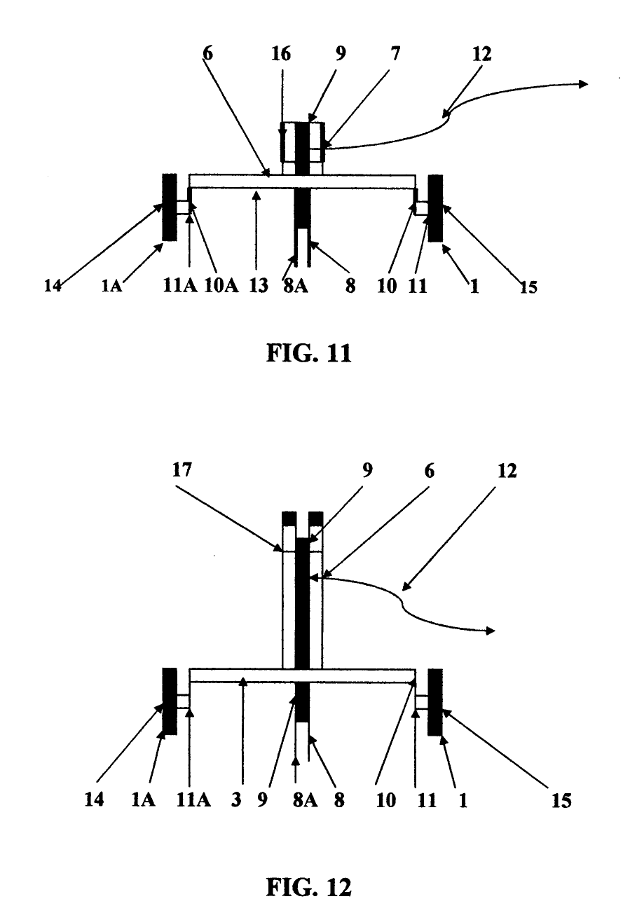

The following improvements delete the mechanical operation of the Sod Buster Apparatus and make use of a hydraulic or electromechanical device as available and desired on the open market. The mounting bracket is added to adjust the depth of the device to be attached and replaces the solid shaft (31) shown in figure (1) of the original patent. Also, the position of the device to be used is moved to behind the rear wheels and wheels support frame (13). In FIGS. 11 & 12 the gas springs (51 &52) are deleted. The upper support brackets (36) for the gas springs (51 & 52) and related items (37 & 38) are deleted. In figure (1 & 2) of the original patent, the chisel plow (30), chisel plow shaft (31), bolts (31 & 32) are deleted in the improvement.

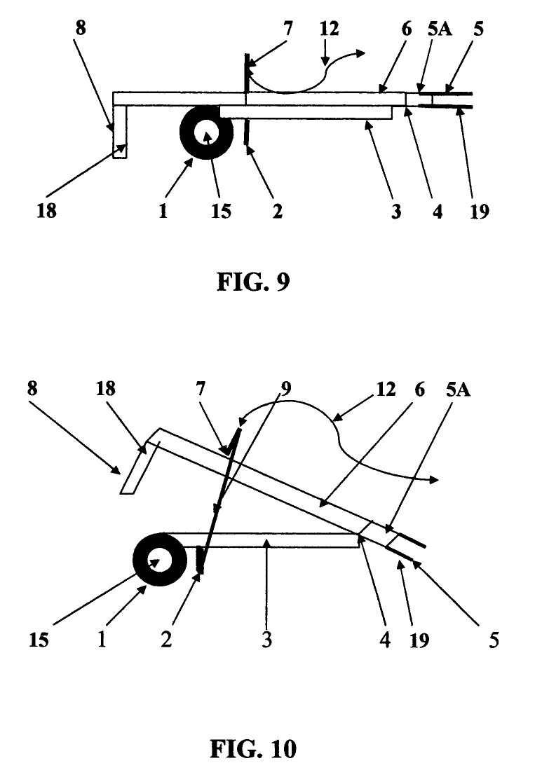

FIG. 9 is a right side view of the preferred embodiment of the One Point Hitch showing the apparatus in the full depth position. FIG. 10 shows the One Point Hitch in the transport position. FIGS. 11 and 12 shows a rear view of the One Point Hitch in the full depth and transport position respectively. As shown in these figures, the One Point Hitch apparatus is constructed of a horizontal support frame (13) consisting of two parallel support frame members (3 & 3A), which are hingedly attached to the transport device frame (6) at one end. Wheel support frame (13) is rigidly attached crosswise to horizontal support frame (3 &3A), forming a 90 degree angle to wheel support frame (13) at opposite ends to receive the One Point Hitch wheels (1 & 1A). The two One Point Hitch wheels (1 & 1A) are attached and rotatable to their respective axle shafts (14 & 15), which are detachably mounted in the matching holes (10 & 10A) in wheel support brackets (11 & 11A).

Transport device frame (5A) in FIGS. 9, 10, is similarly constructed of two support members (6 & 6A) rigidly attached to a transport support extension member (5A) located between transport members (6 & 6A) at one end of transport support frame (5A). Transport support extension member (5) is rigidly affixed to tractor mounting tongue hitch (5) which has a hole (18) through the hitch components to attach the One Point Hitch apparatus to a farm, garden tractor or other type of pulling device.

Attached to upper support frame (6 &6A) are two attachment mounting brackets (8 & 8A) with several height adjustment holes (18) to be used as desired to adjust the depth of the attachment device, not shown, as desired and mounted to the rear of the upper support frame (6) which is positioned to the rear of the two support wheels (1 & 1A).

Attached to the upper support frame (6 &6A) are two lifting device supports (7 & 16). Attached to the lower support frame (3 & 3A) are two lifting device supports (2 & 17). The hydraulic or electromechanical lifting device is mounted between the two supports to raise and lower the upper frame (6 & 6A) from the lower frame (3 & 3A) which raises the two mounting brackets (8 & 8A) which are rigidly mounted to the upper frames(6 & 6A). The electrical cord or hydraulic hose (12) is shown in FIGS. 9, 10, 11, &12 which operates the desired lifting device.

The One Point Hitch apparatus of this invention may be constructed of varying materials. Durability, ease of fabrication, cost and the ability of the frame material to withstand stress and continuous shock while under load are important criteria in the selection of the material for this invention. Materials such as steel tubing, aluminum tubing, reinforced plastic tubing or wood may be used to construct the One Point Hitch apparatus. The preferred material is rectangular steel alloy tubing with 2″×2″ rectangular tubing being the preferred size for construction of the One Point Hitch frames. It has also been found that a 10″ diameter wheel with a tread width of 21/2″ works well with this invention.

1. A detachable apparatus which numerous types of farm and garden type implements can be attached and detached from the One Point Hitch when pulled by a powered means comprising:
a horizontal support frame hingedly attached at one end to a transport device frame, to be know as the lower frame, and attached to two rotatable adjustable height wheels;
a transport device frame, to be known as the upper frame, with an end bracket at one end and affixed to a mounting hitch at the opposite end;
a mounting bracket affixed to one end of the upper frame that allows numerous implements to be attached to and detached from the One Point Hitch;
a lifting device supplied by others that allows the upper frame and lower frame to raise and lower as desired by the operator;
said upper frame being pivotally attached to the lower frame;

2. A detachable apparatus as in claim 1 which the said mounting hitch is a tongue hitch with a mounting hole through the tongue components.

3. A detachable apparatus as in claim 1 in which the said mounting hitch is a trailer type ball hitch.

4. A detachable apparatus as in claim 1 in which the means to raise and lower the mounting brackets with any attachments is an electromechanical or hydraulic type lifting device with necessary wiring or hoses that is powered by the pulling apparatus which is supplied by others.

5. A detachable apparatus with mounting brackets pulled by a powered means which can utilize numerous different types of implements by a detachable means that can achieve many different functions as desired comprising:
an upper frame with a mounting bracket affixed at one end and a trailer type ball mounting hitch or plate type tow hitch affixed at the opposite end;
a horizontal support frame attached to the lower frame at the rear end with two rotatable wheels having adjustable height from the ground and said horizontal support frame hingedly attached to upper device frame and;
an upper frame assembly being pivotally attached to the lower frame and having mounting brackets attached to the opposite end;
a lifting device attached between the upper and lower frames to raise the upper frame with mounting brackets off the ground.
